(19) United States
(12) Patent Application Publication
(10) Pub. No.: US 2012/0205497 A1
(43) Pub. Date: Aug. 16, 2012

(54) METHOD AND APPARATUS FOR STORING AND RECHARGING ELECTRONIC DEVICES

(75) Inventors: Thomas A. Hunt, Encinitas, CA (US); Thomas E. Veloskey, San Marcos, CA (US)

(73) Assignee: Spectrum Concepts, Inc., a California Corporation, Carlsbad, CA (US)

(21) Appl. No.: 13/029,074

(22) Filed: Feb. 16, 2011

(51) Int. Cl. F16L 3/08; B23P 17/04; F16M 13/00

(52) U.S. Cl. 248/49; 248/346.5; 29/428

(57) ABSTRACT

An organizer and method of use is disclosed, wherein the organizer includes a plurality of movable and repositionable walls, and securing devices for movably and repositionally attaching the divider walls to a support to accommodate different sizes and shapes of electronic devices to be stored and recharged. Routing devices position cables for recharging electronic devices leaning against the divider walls.

### FIELD OF THE INVENTION

This invention relates to the general field of organizing for storage and recharging electronic devices. It more particularly relates to media and electronic device storage and recharging the devices.

### BACKGROUND ART

There is no admission that the background art disclosed in this section legally constitutes prior art.

The proliferation of gaming systems, media players, and multimedia content has resulted in users having to deal with large numbers of remotes, media, and other accessories. For example, a family using the Ninetendo® Wii™ may have four remotes, four nun-chucks, four wheels, and dozens of games on a digital video disc (DVD) type disc. Further, this same family may have controllers and/or media for other games systems or media players, such as Sony® Playstation® and Blu-ray players. Such a large number of accessories and media can be overwhelming and lead to a cluttered, disorganized environment.

Devices for storing media are well known in the prior art. Beginning with video home system (VHS) tapes and continuing with compact disc (CD) and DVD media, media cabinets have attempted and many times succeeded in storing large amount of media. With the addition of rechargeable electronic devices such as controllers, remotes, and other multimedia accessories, as well as other rechargeable electronic devices such as cell phones and digital cameras, storing and recharging once again became an issue. The prior art has continued to struggle with a convenient, easy, and efficient way of storing media and accessories in one convenient location.

Thus there has existed a long-felt need to a media and multimedia accessory storage device that stores accessories and media in a convenient, easy, and efficient manner as well as integrates into existing and new cabinets without difficulty.

There have been many different types and kinds of organizers and similar structures used for a variety of different purposes. For example, reference may be made to the following: U.S. Pat. No. 7,296,775 to Mayer; U.S. 20060169187 to Hoffman; U.S. Pat. No. 6,447,078 to Zheng; U.S. Pat. No. 6,837,386 to Kent; U.S. Pat. No. 7,225,633 to DeMars; U.S. Pat. No. 6,848,588 to DeNatale; U.S. 20050076817 to Boks; U.S. 20080134551 to Conforti, et al.; U.S. 20030196970 to Jiang; U.S. Pat. No. 7,296,775 to Mayer; U.S. Pat. No. 6,017,108 to Domenig; U.S. Pat. No. 4,738,495 to Mitts; U.S. Pat. No. 3,794,952 to Dowis; U.S. Pat. No. 3,170,741 to Richards, Jr.; U.S. D401810 to Swift; U.S. 20040104188 to Russell, et al.; U.S. Pat. No. 7,748,537 to Manger; U.S. Pat. No. 6,588,609 to Richet et al.; U.S. Pat. No. 5,894,944 to Swift; U.S. Pat. No. 4,433,885 to Baker; U.S. Pat. No. 3,484,145 to Skalka; and U.S. D575986 to Cetera; U.S. Pat. No. 7,109,864 to Maloney; WO 2004/050798 to Redmond; EP 0550282A3 to Edward; and EP 0296496 to McInnes.

While there have been these types and kinds of organizers as well as many others for media and other devices, there remains the problem of having a universal organizer for media and electronic devices including but not limited to game controllers, mobile telephones, electronic cameras and many others. In this regard, when a furniture manufacturer includes a media organizer in its furniture such as a cabinet or entertainment center, it is usually designed for specific devices such as game controllers, or alternatively media. However, a given purchaser of such furniture may not have a need for both media such as CDs and DVDs, as well as game controllers or other electronic devices. Alternatively, even if the user of the furniture has a need for storing and re-charging such devices and media, it is not uncommon for the user to acquire new types and kinds of electronic devices such, for example, as game controllers. The organizers supplied with the furniture unit may no longer be entirely adequate or functional for the new devices. In short, the prior known organizers have not been satisfactory for all users and are not adapted to be able to receive new and different electronic devices as they become available to the user.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 is a pictorial view of an organizer constructed according to an embodiment of the present inventions.

FIG. 2 is a top view of the organizer of FIG. 1.

FIG. 3 is an elevational view of the organizer of FIG. 1.

FIG. 3A is an end view of the organizer of FIG. 1.

FIG. 4 is a pictorial view of an organizer constructed according to another embodiment of the present invention.

FIG. 5 is a top view of the organizer of FIG. 4.

FIG. 6 is an elevational view of the organizer of FIG. 4.

FIG. 7 is an end view of the organizer of FIG. 4.

FIG. 8 is a pictorial view of an organizer constructed according to yet another embodiment of the present invention.

FIG. 9 is a top view of the organizer of FIG. 8.

FIG. 10 is an elevational view of the organizer of FIG. 8.

FIG. 11 is an end view of the organizer of FIG. 8, being illustrated with a portion thereof broken away for illustration purposes.

FIG. 12 is a pictorial view of an organizer constructed according to a further embodiment of the present invention.

FIG. 13 is a top view of the organizer of FIG. 12.

FIG. 14 is a side view of the organizer of FIG. 12.

FIG. 14A is a pictorial view of an organizer constructed according to a still further embodiment of the invention.

FIG. 14B is a pictorial view of the organizer of FIG. 14A taken from a different perspective.

FIG. 15 is a pictorial view of an organizer, which is constructed according to an embodiment of the invention, and which is shown affixed to a rod within a furniture cabinet.

FIG. 16 is a top view of the organizer of FIG. 15.

FIG. 17 is a front view of the organizer of FIG. 15.

FIG. 18 is a pictorial view of the furniture cabinet organizer shown in FIG. 15, with alternative contents stored therein.

FIG. 19 is a top view of the organizer of FIG. 15.

FIG. 20 is a front view of the organizer of FIG. 15.

FIG. 21 is a pictorial view of the organizer of FIG. 15 shown removed from the cabinet.

FIG. 22 is a front view of the organizer of FIG. 15.

FIG. 23 is a top view of the organizer of FIG. 15.

FIG. 24 is a bottom view of the organizer of FIG. 15.

FIG. 25 is an alternative pictorial view of the organizer of FIG. 15.

FIG. 26 is yet another pictorial view of the organizer of FIG. 15.

FIG. 27 is a front view of the organizer of FIG. 15 at different vertical positions along the length of the rod.

FIG. 28 is a top view of the organizer of FIG. 15.

FIG. 29 is a sectional view of the organizer of FIG. 15 taken along the section line 29-29 shown in FIG. 28.

FIG. 30 is a detailed view of the circled portion of the movable wall lever area of FIG. 29.

FIG. 31 is a sectional view similar to FIG. 29. The latch is unlatched in this view, but the wall is not fully lifted away as in FIG. 32.

FIG. 32 is a sectional view similar to FIG. 29 with the lever shown in the open position and the movable wall shown separated from the multimedia storage organizer.

FIG. 33 is a top view of the organizer of FIG. 15 with a controller insert tray inserted thereto.

FIG. 34 is a sectional view of the organizer of FIG. 15 taken along the section line 34-34 shown in FIG. 33.

FIG. 35 is a pictorial view of the organizer of FIG. 15 with eight controller insert trays installed thereto.

FIG. 36 is a pictorial view of the organizer of FIG. 15 with four controller insert trays installed thereto, with gaps between adjacent trays.

FIG. 37 is a pictorial view of the organizer of FIG. 15 with bare discs installed in the bare disc slots.

FIG. 38 is a top view of the organizer of FIG. 15.

FIG. 39 is a pictorial view of the organizer of FIG. 15 with bare disc and DVD style media cases installed thereto.

FIG. 40 is a top view of the organizer of FIG. 15.

FIG. 41 is a pictorial view of the organizer of FIG. 15 with bare disc, DVD style, and Playstation® 3 or Blu-ray media style cases installed thereto.

FIG. 42 is a top view of the organizer of FIG. 15.

FIG. 43 is a pictorial view of another embodiment of an organizer which is constructed according to a further embodiment of the invention. This is actually the same organizer as FIG. 15 with a sidewall mount bracket instead of the tube mount.

FIG. 44 is a sectional view of the organizer of FIG. 43 taken substantially along the line 44-44 thereof.

FIG. 45 is a bottom view of the organizer of FIG. 44.

FIG. 46 is a pictorial view of an organizer which is made according to yet a further embodiment of the invention.

FIG. 47 is a top view of the organizer of FIG. 46.

FIG. 48 is a sectional view of the organizer of FIG. 47 taken substantially on line 48-48 thereof.

FIG. 49 is a bottom view of the organizer of FIG. 46.

### DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed, but is merely representative of the embodiments of the invention.

According to certain embodiments of the present invention, there is provided an organizer for storing and recharging electronic devices. The organizer includes a support having a support surface for receiving and supporting the electronic devices. A plurality of divider walls movably and repositionally adjustably mounted on the support surface in a substantially spaced apart arrangement in an upright position receive electronic devices leaning against them. Securing devices attach the divider walls in an upright manner on the support surface. Routing devices position cables to the electronic devices leaning against the divider walls to maintain cables relative to individual divider walls and to facilitate recharging the electronic devices. A series of slots may be provided for receiving media for storage in a generally upright manner. The divider walls can be repositioned relative to other ones of the divider walls to accommodate different sizes and shapes of electronic devices.

According to other embodiments of the present invention, an organizer has a support with a plurality of movable open top bins on the support surface for receiving and supporting individually electronic devices in upright closely spaced manner. Securing devices attach the bins on the support surface to enable the accommodation of different sizes and shapes of electronic devices. Routing devices position the cables relative to the bins for recharging electronic devices stored individually in the bins. In this manner, the electronic devices can be stored and recharged in the bins and other electronic devices can be stored and recharged on the support surface between the bins.

Other embodiments of the present invention relate to an organizer having a plurality of divider walls mounted adjustably on a support surface for storing electronic devices leaning against the divider walls. A series of holders for supporting media in an upright manner are disposed on the support surface. The divider walls can be repositioned relative to other ones of the divider walls to accommodate different types and kinds of electronic devices.

Further embodiments relate to an organizer having a series of parallel space-apart upstanding divider walls fixed to a support surface where pairs of the divider walls define side walls for enabling the electronic devices to lean against the divider walls while resting on the support surface. Cable routing devices position cables relative to the divider walls to recharge the electronic devices. Each bin has a depth of at least about 1 inch, a width between the divider walls of between about 1 inch and about 3 inches, and a length of at least about 5 inches.

Further embodiments of the present invention relate to a method of using an organizer where a support is provided and has movable divider walls on a support. The method includes relocating a divider wall on the support surface relative to another one of the divider walls to accommodate a certain electronic device therebetween, and lean a certain electronic device on the adjusted divider wall in a generally upright position. Power cables are connected to the electronic devices for recharging them.

Another embodiment of the invention relates to a multimedia storage unit which may mount on a rod affixed within a furniture cabinet or the like and may rotate about the rod to extend outside of the cabinet. The vertical position of the multimedia storage unit relative to the rod may be adjusted and locked to suit the needs of the user. Multiple multimedia storage units may be affixed to the same rod. Cabling may be accommodated by the multimedia storage unit to allow for recharging of game controllers or other electronic devices.

A multimedia storage unit can mount on a rod affixed within a furniture cabinet and rotates about the rod to extend outside of the cabinet. The vertical position of the multimedia storage unit relative to the rod may be adjusted and locked to suit the needs of the user. Multiple multimedia storage units may be affixed to the same rod. Cabling may be accommodated by the multimedia storage unit to allow for recharging of game controllers, phones, cameras, MP3 players, and other devices. Each multimedia storage unit may be configurable to store media alone, accessories alone, or a combination thereof, through the use of a minimum number of custom storage trays.

The radial gaming and media organizer of one embodiment of the current invention includes one or more multimedia storage units. Slots for media may be radially presented in the organizer. Trays or walls may be moveably secured to the slots to provide bins for storing accessories such as game controllers. The multimedia storage unit may include a means to secure itself to a rod, wherein the multimedia storage unit may rotate about the rod. Alternatively, the multimedia storage unit may mount directly to the furniture cabinet or the like, wherein a separate means to rotate the multimedia storage unit into and out of the furniture cabinet may be provided. The arcuate shape such as a quarter-circle shape of the multimedia storage unit allows it to rotate about the rod into and out of a furniture cabinet while staying within its original footprint. Multiple multimedia storage units may be secured to the same rod, the vertical positions of which may be adjusted accordingly.

According to at least one embodiment of the invention, an organizer may store both media and electronic devices such as accessories within a furniture cabinet or the like. Such an organizer may enable users to quickly access desired media and/or electronic devices.

Still another embodiment of the invention relates to a means for routing cables to electronic devices stored in the organizer to allow for the charging and/or syncing of them.

There has thus been outlined, rather broadly, the more important features of the invention in order that the detailed description thereof may be better understood, and in order that the present contribution to the art may be better appreciated. There are many additional features of embodiments of the invention that will be described hereinafter and which will form the subject matter of the claims appended hereto. The features listed herein and other features, aspects and advantages of various aspects of the present invention will become better understood with reference to the following description and appended claims.

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

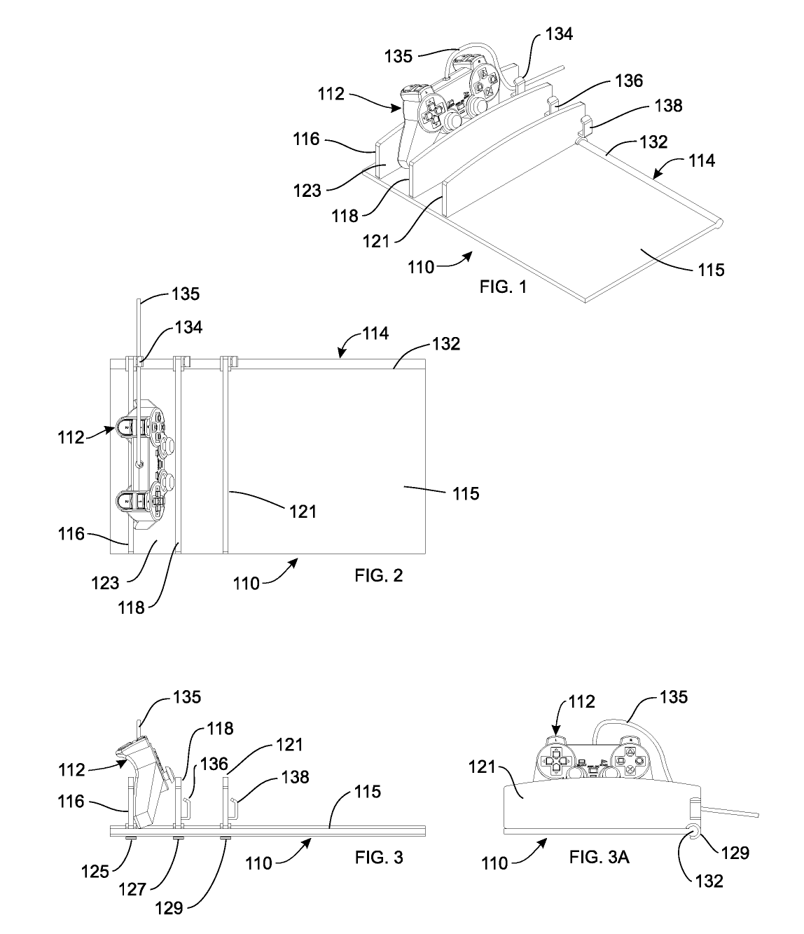

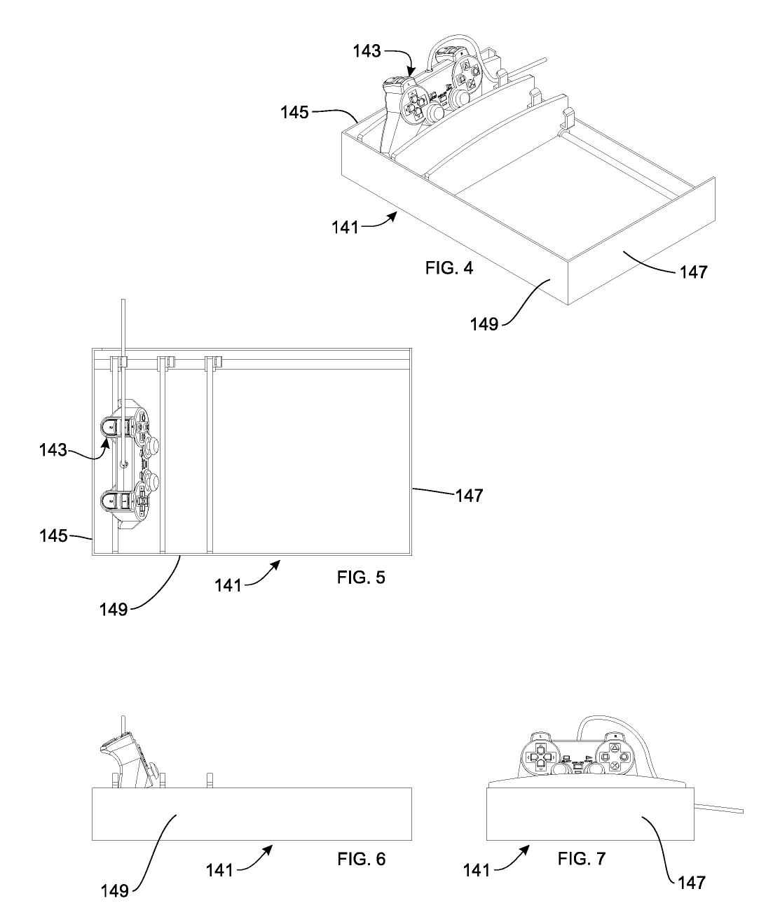

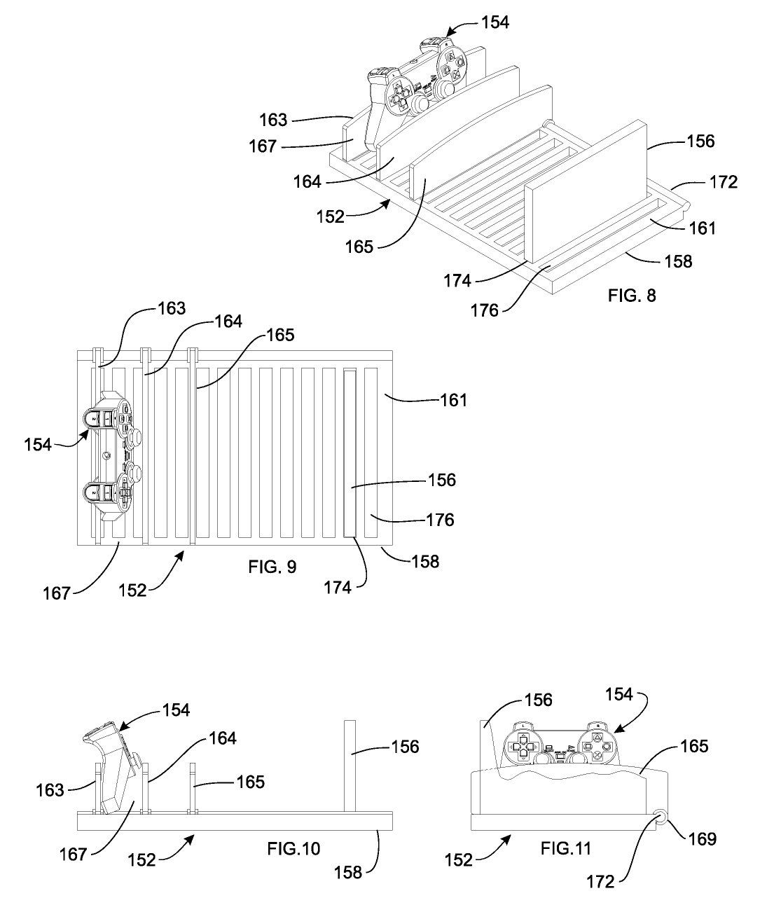

Referring now to the drawings, and more particularly to FIGS. 1, 2, 3 and 3A, there is shown an organizer 110 for storing and recharging electronic devices such as the game controller 112. The organizer 110 includes a support 114 having a support surface 115 on which is mounted a series of divider walls 116, 118 and 121. Pairs of walls such as the walls 116 and 118 together with the support surface 115 form a bin 123 which receives the electronic device 112. Each divider wall is generally rectangular in shape and is in the form of a thin flat plate.

A wall movable mount is disposed on each divider wall and is in the form of a rectangular C-shaped retainer such as the retainers 125, 127 and 129 on the divider walls 116, 118, and 121, respectively. The retainers receive a beaded edge 132 to enable the divider walls to be moved adjustably.

Cable routing devices such as a securing clip 134 on the divider wall 116, are provided for each one of the divider walls. In this manner, cables such as a cable 135 for the electronic device 112 can be maintained and located relative to the bin 123 for charging the electronic device 112. In this regard, the other end of the cable 135 (not shown) is able to be connected to a source of electrical power for recharging the electronic device 112. Similarly, a pair of cable securing devices 136 and 138 are mounted on the other two divider walls 118 and 121, respectively.

In this manner, the divider walls can readily be repositioned to accommodate various different sizes and shapes of electronic devices in a customizable manner by the user. The cable routing devices such as the securing clip 134 maintains the cables for the stored electronic devices in a convenient manner relative to the bins such as the bin 123 after the divider walls have been repositioned.

Referring now to FIGS. 4, 5, 6 and 7 of the drawings, there is shown another organizer 141 which is similar to the organizer 110 of FIG. 1 except that it is in the form of a tray having sidewalls. The organizer 141 is adapted to store electronic devices such as the game controller 143. The organizer 141 has pair of end walls 145 and 147, together with a side wall 149. The overall shape of the organizer 141 is rectangular and is adapted to rest on a supporting surface.

Referring now to FIGS. 8, 9, 10 and 11, an organizer 152 is similar to the organizer 110 of FIG. 1 except that it stores both electronic devices such as the electronic device 154, as well as media such as CDs and DVDs. In this regard, for example, media 156 as well as the electronic device 154 are stored in a generally upright position on a support 158 having a support surface 161. The organizer 152 includes divider walls 163 and 164 which together with the support surface 161 form a bin 167 for receiving the electronic device 154 leaning against the wall 163. All together the organizer 152 includes a series of parallel space-apart upright movable divider walls 163, 164 and 165, and can have a fewer or greater number of the like divider walls.

As best seen in FIG. 11, a series of wall movable mounts such as a movable mount 169 for the divider wall 165 are adapted to receive a beaded edge 172 in a similar manner as the organizer 110 of FIG. 1. A series of holders are arranged in a parallel spaced-apart manner on the support surface 161 for storing media such as the media 156. The holders are in the form of elongated media slots such as the slot 174 and the slot 176.

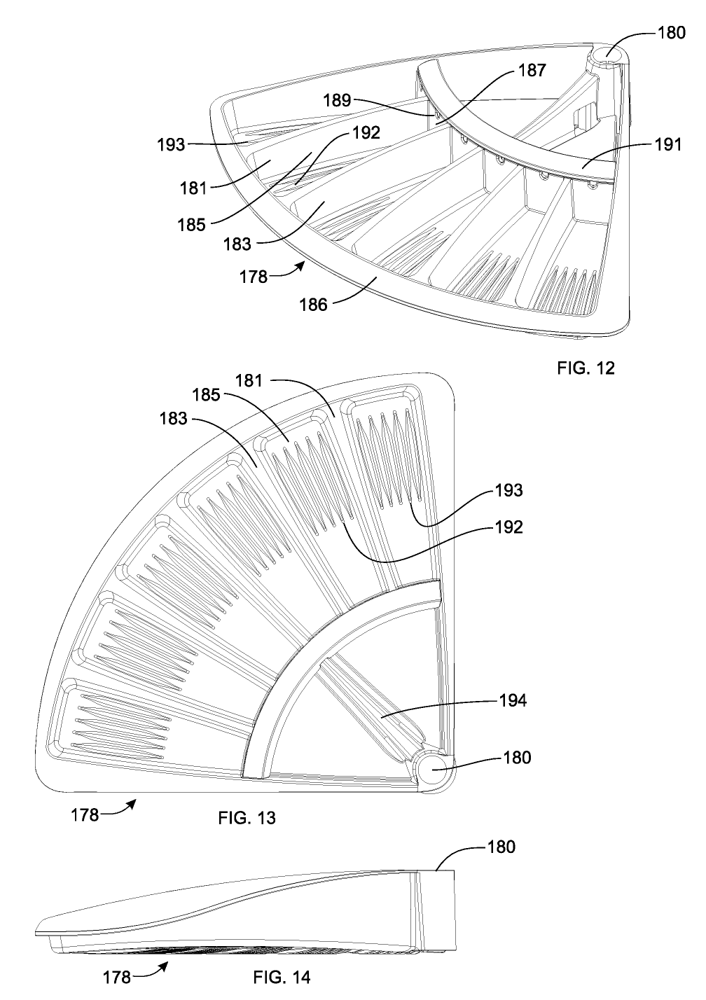

As shown in FIGS. 12, 13 and 14, an organizer 178 is similar to the organizer 110 of FIG. 1, except that it is a rotatable organizer which may be mounted in a furniture cabinet as hereinafter described in greater detail. The organizer 178 includes an axle opening 180 for receiving a post or rod (not shown) to rotate thereabout in a horizontal plane. A series of fixed divider walls are similar to the movable divider walls of the organizer 110 and include fixed divider walls 181 and 183 which define a bin 185 for receiving an electronic device (not shown).

The organizer 178 is generally triangular in shape and includes an arcuate front wall 186 as well as a pair of straight side walls 182 and 184 forming a corner portion where the axle opening 180 is disposed.

A routing device such as the routing device 189 in the form of a notch, is disposed in each bin such as the bin 185 for receiving an electrical cable for an electronic device to secure it in place to charge the electronic device. A removable arcuate wall 191 covers over the cables in the notches such as the notch 189 of the rear wall 187 to retain and conceal the cables in place.

A series of media holders in the form of media slots such as the media slots 192 and 193 are provided in the support surface to receive bare media in the spaces between the fixed divider walls. A cable routing channel 194 on the underside of the organizer 178 as best seen in FIG. 13 receives cables from electronic devices (not shown) through an opening 194A near the pivot in the support surface and positions the cables (not shown) near the pivot point at the axle opening 180.

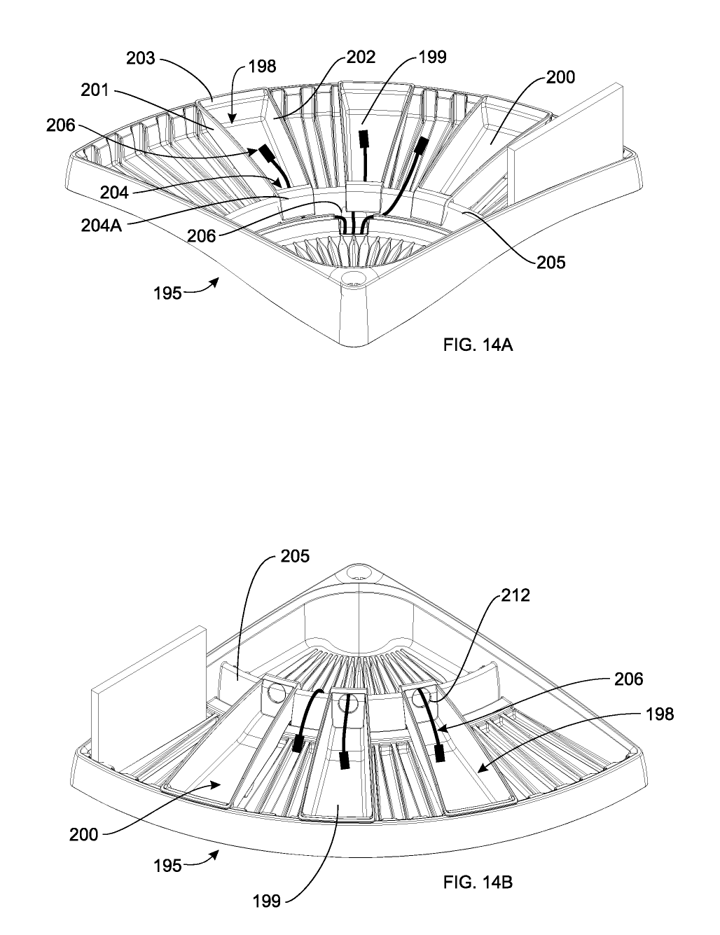

Referring now to FIGS. 14A and 14B, there is shown an organizer 195 which is a rotatable organizer similar to the organizer 178, except that the organizer 195 includes a plurality of like movable open top bins 198, 199 and 200. Each bin such as the bin 198 is in the form of an open top box which is generally trapezoidal in shape extending radially in desired positions on the support surface of the organizer 195. The bin 198 includes a pair of divider walls 201 and 202 with an outer curved end wall 203 and an inner curved end wall 204. The inner curved end wall 204 includes a securing device in the form of a clip 204A which fits over a fixed arcuate wall 205 so that the bin can be moved to adjusted positions by manually grasping the bin and sliding it along the arcuate wall 205.

Cables such as cable 206 for recharging electronic devices (not shown) extend between the interior of the bins such as the bin 198 through an opening 212 in the inner curved end wall 204 of the bin 198 to an opening in the supporting surface of the organizer 195, to the underside thereof.

The hole 212 in the rear end wall such as the rear end wall 204 enables the cable 206 to extend over the top edge of the arcuate wall 205 and then through an opening in the support surface for the organizer 195.

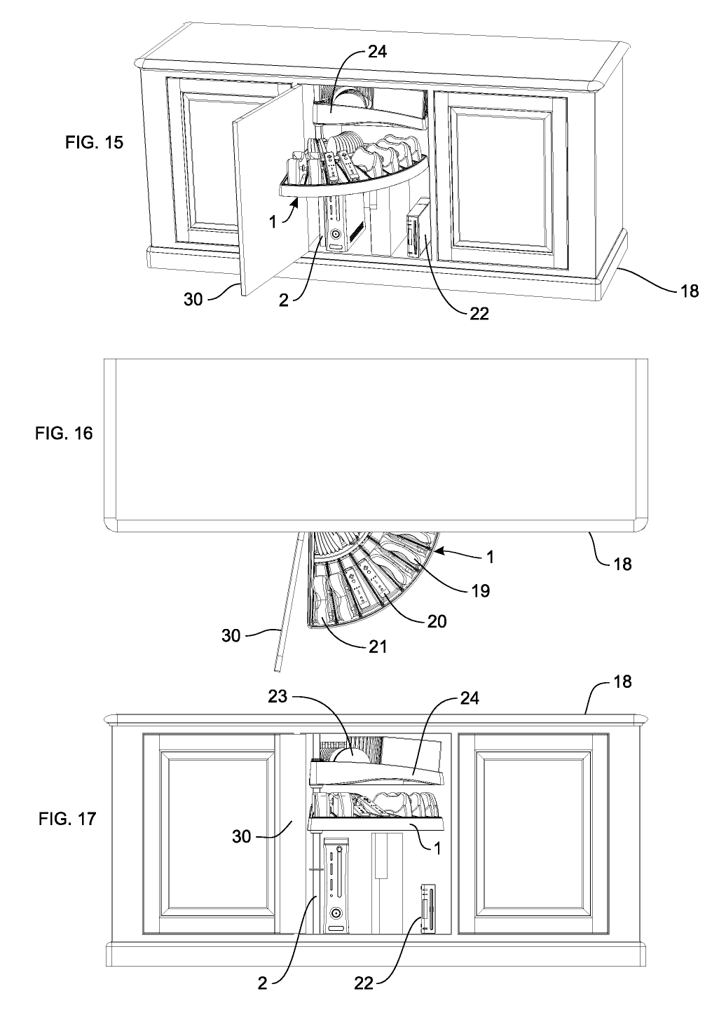

FIGS. 15-17 are a pictorial view of a furniture cabinet 18 with a pair of multimedia storage organizers 1 and 24 constructed according to an embodiment of the present invention and affixed to a square tube or rod 2 within the furniture cabinet. The organizers are each radial gaming and media organizer, according to certain embodiments of the current invention, preferably resides within the furniture cabinet 18. The furniture cabinet 18 has a door 30 that allows access to an inside compartment of the furniture cabinet 18. In the drawings, two multimedia storage organizers 1 and 24 are affixed rotatably to the vertical rod 2 in a vertically spaced apart manner, however, a fewer or greater number of organizers may be fixed rotatably to the rod 2. The multimedia storage units 1 and 24 are affixed towards the top of the rod 2 to allow for the storage of gaming consoles 22 underneath within the cabinet 18.

The multimedia storage organizers 1 and 24 each rotate about the rod 2 independently into and out of the furniture cabinet 18. Users gain access to items disposed on the multimedia storage organizer 1 by accessing the furniture cabinet 18, such as by opening the door 30, and then rotating the multimedia storage organizer 1 about rod 2 and out of the furniture cabinet 18. After removing and/or placing items from or into the multimedia storage unit 1, it is rotated about rod 2 back into the furniture cabinet 18, at which time the door 30 may be closed to conceal from view the radial gaming and media organizers.

FIG. 16 is a top view of the furniture cabinet 18, illustrating the multimedia storage organizer 1 shown substantially extended out of the furniture cabinet 18. The door 30 is open to allow access to the contents within the furniture cabinet 18, including the multimedia storage organizer 1. Various game controllers, including Xbox® controllers 21, Wii™ controllers 20, and Playstation® 3 controllers 19, are stored in the multimedia storage unit 1. Other accessories (not shown) may be stored therein, including without limitation cell phones, portable audio players such as MP3 players, cameras, and portable game systems as well as others.

FIG. 17 is a front view of the furniture cabinet 18 illustrating the two multimedia storage organizers 1 and 24 affixed to the rod 2 within the furniture cabinet with the door 30 of the furniture cabinet 18 opened. Two multimedia storage organizers 1 and 24 are shown affixed near the upper end of the rod 2 to allow sufficient space for gaming consoles 22 within the furniture cabinet 18 below the organizer. The lower multimedia storage organizer 1 is shown storing various gaming controllers. The upper multimedia storage organizer 24 is shown storing bare discs 23 and media cases 10.

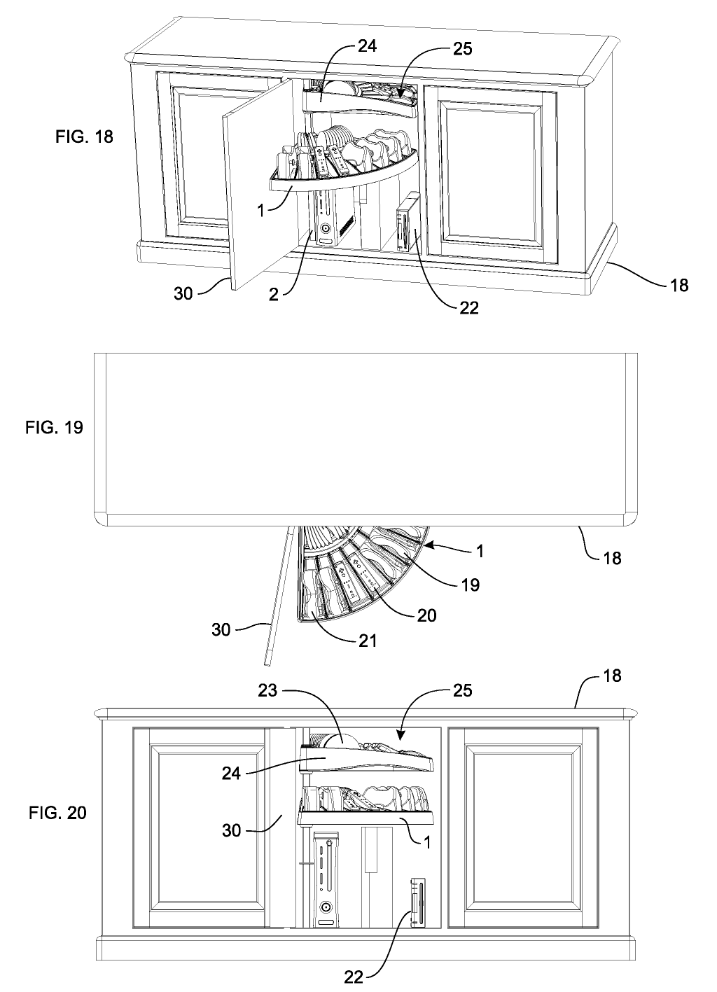

FIGS. 18 through 20 are similar views of the furniture cabinet and organizers 1 and 24 shown in FIGS. 1 through 3, with alternative contents in the upper multimedia storage organizer 24. Specifically, there are additional game controllers generally indicated at 25 in the upper multimedia storage organizer 24 instead of media cases.

FIG. 21 is a pictorial view of the multimedia storage organizer 1 and rod 2 shown removed from the cabinet 18. The multimedia storage unit 1 is affixed to the rod 2, which is preferably tubular in shape, and even more preferably has a square cross section throughout its axial length. The rod 2 passes through an opening in the multimedia storage organizer 1. The vertical position of the multimedia storage organizer 1 may be varied positionally along the length of the rod 2, where a height adjustment lever 8 is used to secure the multimedia storage organizer 1 in a specific desired adjusted position along the axial length of the rod 2.

The rod 2 adopted to be mounted vertically includes a top rod mount 14 and a bottom rod mount 15. These mounts, in a preferred embodiment, are used to secure the rod 2 to a furniture cabinet or other furniture article. However, these mounts may be used to secure the rod to other surfaces, including rod extensions to increase the overall height of the radial gaming and media organizer such as the organizers 1 and 24, to fit particular applications.

FIGS. 15-20 show the radial organizer in a conventional furniture cabinet 18. For this cabinet style the square tube rod 2 may mount to the upper and lower surfaces of the cabinet opening, although it may also be possible to mount it to the side wall as well. Some cabinets may not allow mounting on both surfaces and therefore, the tube rod 2 could be attached to only one of the surfaces.

While two radial organizers are shown installed, it should be understood that as many organizers as space allows may be accommodated and that the rod alone may be added so that radial organizers may be added only as needed.

The square tube rod 2 may be used to provide indexing of the radial organizers in an open or closed position. The flat sides of the square tube rod interface to the top or bottom tube rod mounts to prevent the square tube from rotating relative to the cabinet. With the tube fixed relative to the cabinet the radial organizer provides a detent or a self close mechanism to fixed positions in relation to the tube rod. If this indexing function is not required, the rod may be allowed to rotate relative to the cabinet, or a found tube rod (not shown) may be used. It should also be noted that shapes other than square may be used for indexing, such as rectangular or hexagonal. The tube may be removable from the cabinet to allow for installation and removal of the radial organizers.

The radial organizers slide on the support rod and has the height adjust lever 8 which locks the radial organizer in position along the axial length of the rod 2. This lever 8 is easily accessible so the user can adjust the height as needed depending upon the contents to be stored.

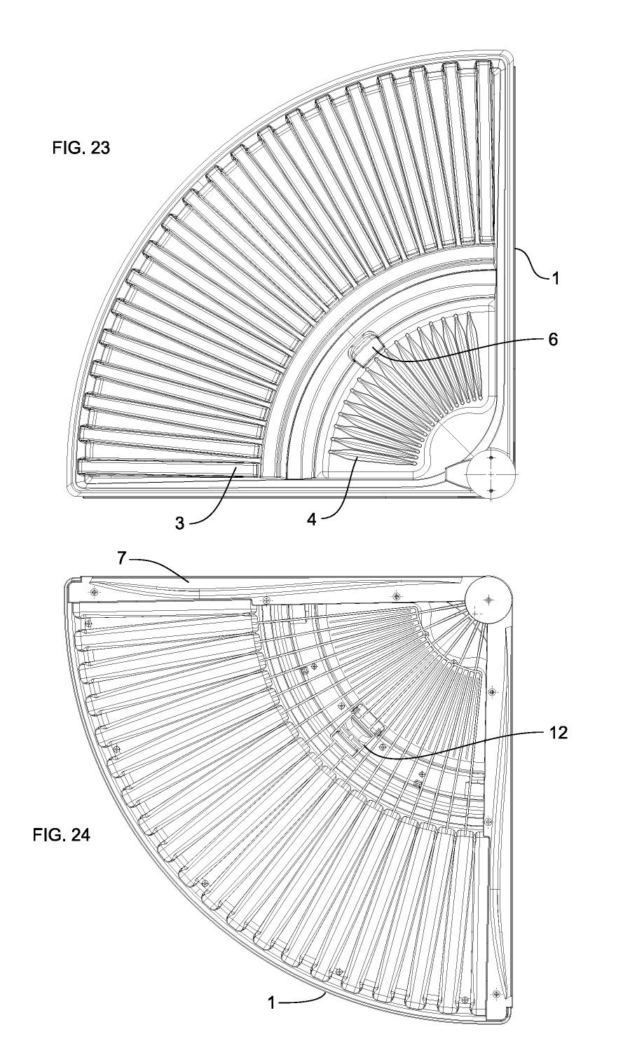

As shown more clearly in FIGS. 23 and 24, the multimedia storage organizer 1 preferably is in the shape of one-quarter (¼ ) of a circle. This shape allows the multimedia storage organizer 1 to rotate ninety degrees)(90°) about the rod 2 into and out of a furniture cabinet. Thus, substantially all, if not all, of the multimedia storage organizer 1 may rotate out of the furniture cabinet while also allowing the entire multimedia storage organizer 1 to rotate back into the furniture cabinet. The circular shape along the outside of the multimedia storage organizer 1 results in the multimedia storage organizer 1 never extending beyond its radial length relative to the rod 2 regardless of its rotation about the rod 2. Depending on the dimensions of the furniture cabinet in which the radial gaming and media organizer is to reside, the multimedia storage organizer 1 may be more or less than one-quarter of a circle, though preferably still within the range of three-sixteenths and five-sixteenths of a circle. It should be understood that a one-half round circular shape would also be contemplated as another embodiment of the invention.

The inner portion of the multimedia storage organizer 1 includes a plurality of parallel equally spaced apart bare disc slots 4. The bare disc slots 4 are recessed areas that are designed to accommodate standard size optical discs, such as DVDs, CDs, and similarly sized media. The bare disc drops into one of the bare disc slots 4 and is supported by the edges of the bare disc slot 4. The bare disc is allowed to move or shift slightly from side to side within a bare disc slot 4 to allow a user to move one bare disc to gain better visibility of an adjacent bare disc. The bare disc slots 4 are also designed to prevent contact with the upper or lower planer surfaces of the bare disc to prevent damage thereto.

The outer portion of the multimedia storage organizer 1 includes a plurality of media slots 3. The media slots 3 are recessed areas that support various types of media cases, such as DVD, Blu-ray, Xbox®, Wii™, Playstation® 3, Nintendo DS, and other similarly sized cases. These various types of media cases are supported by the media slots 3 through steps and channels such that one slot may support media cases of different sizes and shapes.

A removable wall 5, discussed in more detail below, is located between the media slots 3 and the bare disc slots 4.

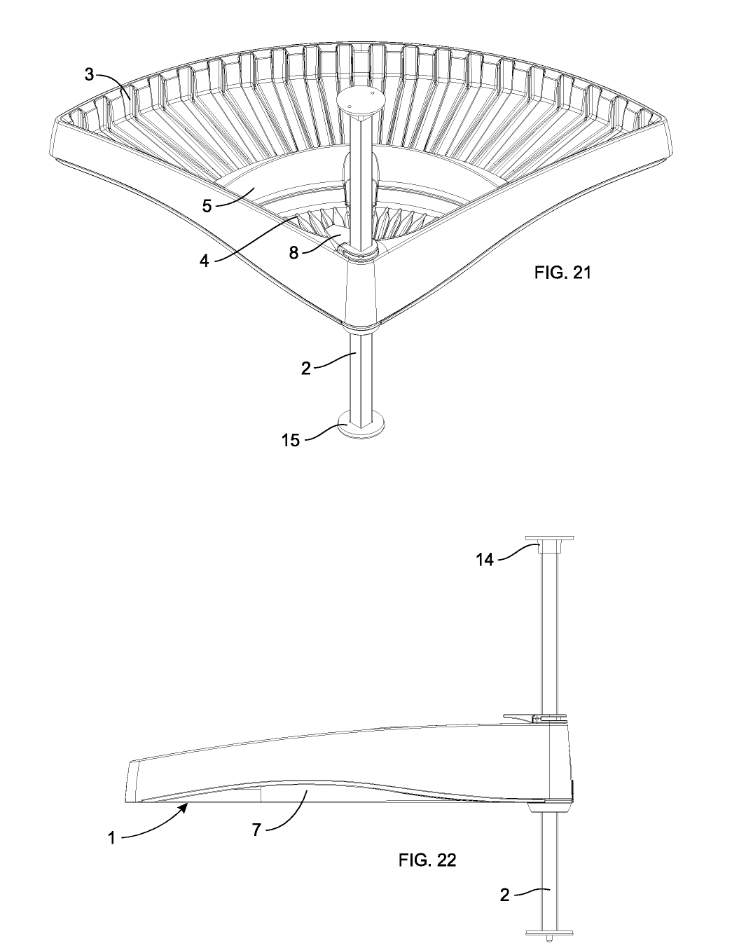

FIG. 22 is a front view of the multimedia storage unit and rod. Handles 7 may be integrated into the multimedia storage organizer 1 and provide a convenient location to grasp and rotate the multimedia storage organizer 1 into and out of a furniture cabinet. The handles 7 may also provide a cosmetic accent to the multimedia storage organizer 1 and to the radial gaming and media organizer overall. However, the multimedia storage organizer 1 need not have the handles, since the multimedia storage unit may be grasped with or without the handles.

FIG. 23 is a top view of the multimedia storage organizer and rod. A removable wall lever 6 enables users to secure and remove a removable wall 5 to the multimedia storage unit 1.

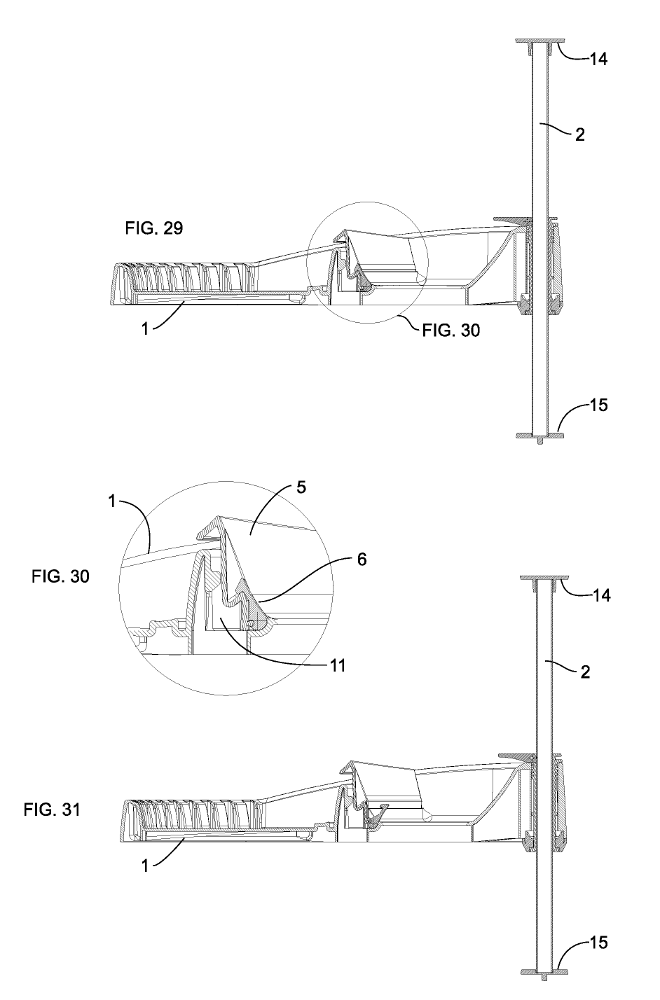

FIG. 24 is a bottom view of the multimedia storage organizer and rod. A cable routing hole 12 is located in the bottom of the multimedia storage organizer 1. The cable hole 12 allows cables to extend from beneath the multimedia storage organizer 1 into a trough beneath the removable wall (more clearly shown in FIGS. 29-32), and should be sufficiently large to allow for standard 110V two-pronged electrical plugs to pass through.

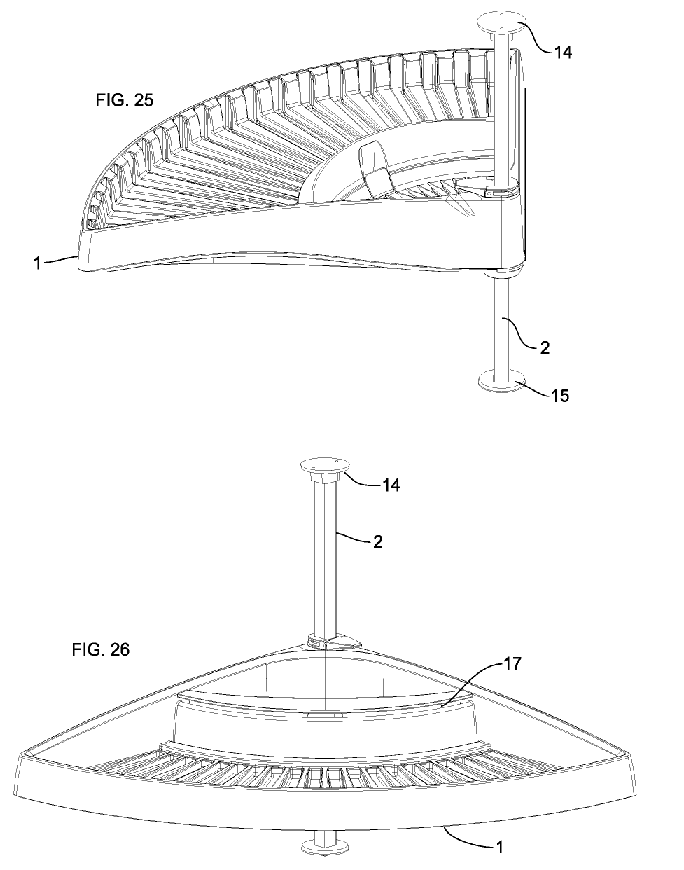

FIG. 25 is a pictorial view of the multimedia storage organizer 1 and rod 2. The removable wall lever 6 is shown in the closed position, wherein the removable wall 5 is locked in place. An opening 24 allows a user to place a finger behind the removable wall lever 6 to pull it to an open position.

FIG. 26 is yet another pictorial view of the multimedia storage organizer and rod. A fixed wall 16 is adjacent to the media slots 3. The removable wall 5 is adjacent to the fixed wall 16. A cable slot 17 is formed between the removable wall 5 and the fixed wall 16.

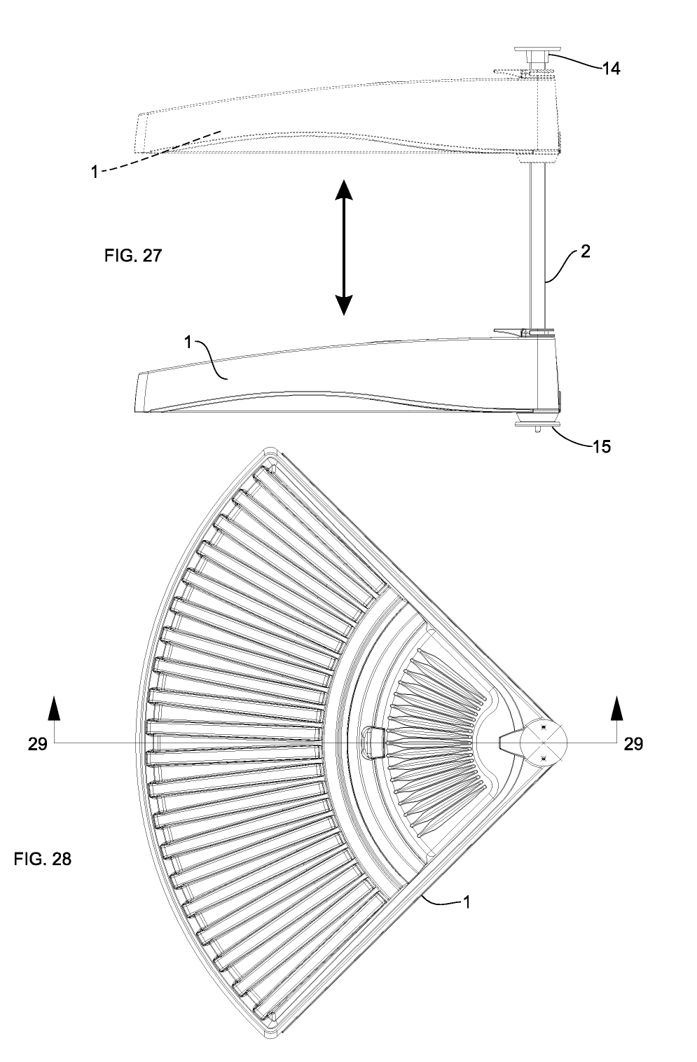

FIG. 27 is a front view of the multimedia storage organizer at different vertical positions along the length of the rod. The height adjust lever 8 is used to secure the multimedia storage unit 1 along the length of the rod 2. By pulling the height adjust lever 8, the position of the multimedia storage unit 1 along the length of the rod 2 may be adjusted. As shown in this figure, the vertical position of the multimedia storage unit 1 can be adjusted from the top to the bottom of the rod 2. Preferably, a twist lock is used to lock the multimedia storage unit 1 to a particular location along the length of the rod 2.

FIG. 28 is a top view of the multimedia storage organizer and rod in FIG. 27.

FIG. 29 is a cross sectional view of the multimedia storage organizer and rod along the section line 29-29 shown in FIG. 28. The removable wall lever 6 is shown in the closed position, which locks the removable wall 5 to the multimedia storage unit 1. Cable trough 11 allows cables that pass through the cable hole 12 (also shown in FIG. 24) to travel along the length of the fixed wall 16 and out through cable slot 17. The multimedia storage unit also includes a mounting hole 28 with two openings through which the rod 2 extends. The height adjust lever 8 is adjacent to one of the openings of the mounting hole 28, preferably the top opening.

FIG. 30 is a detailed view the removable wall lever area. The removable wall lever 6 is in the closed position, which locks the removable wall 5 to the multimedia storage organizer 1. A protrusion 25 extends out from the fixed wall 16 and supports the removable wall 5. The fixed wall 16 and the removable wall 5 are prevented from closing together, which would eliminate the cable slot 17, because of the protrusion 25. Note, however, that the protrusion 25 does not extend the entire length of the fixed wall 16. In fact, it preferably extends only the length of the opening 24. This provides adequate support for the removable wall 5 while at the same time allowing cables to pass through the cable hole 12, along the cable trough 11, and out through the cable slot 17. The removable wall 5 also includes an extension 26 along the bottom portion where it meets the removable wall lever 6. The extension 26 mates with a cavity 27 of the removable wall lever 6. As the removable wall lever 6 is moved from the closed position to the open position, the extension 26 is forced upwards away from the multimedia storage unit 1 by the cavity 27 of the removable wall lever 6.

The removable wall lever is preferably made from a flexible, yet resilient material, such as a rigid plastic. It will bend slightly, but return resiliently to its original shape. This allows the removable wall lever to snap into place.

FIG. 31 is a cross sectional view of the multimedia storage organizer and rod along the section line 29-29 shown in FIG. 28 with the removable wall 5 and lever 6 shown in the open position. The removable wall lever 6 is shown in the open position and has pushed the removable wall slightly up and away from the multimedia storage organizer 1.

In summary, FIGS. 21-31 show details of the empty radial organizer. Features to note include:

Media Slots 3—These features in the lower surface of the tray support and contain various type of media cases such as DVD, Blu-ray, Xbox, Wii, PS3 and Nintendo DS cases. Since these are currently the most popular case formats, other media cases may work as well. These slots capture the different media types through steps and channels so that one slot can store all types supported.

Bare Disc Slots 4—The slots are designed to accommodate the standard size optical disc, commonly used for all CD's, DVD's and games. The bare disc drops into the slot and is supported by the edges so that the disc is allowed to flip from side to side. This allows the user to flip one disc forward to offer better visibility of the following disc face. The slot it also designed to prevent contact with the upper or lower surface of the disc to prevent damage.

Removable wall 5—This wall works in conjunction with a lever to lock into the tray. Once the lever is released, it will drive the wall out of the tray until it is free of the tray and can be lifted off. The removable wall exposes a cable trough behind the fixed wall on the tray. It also can secure cables that pass through the cable slot. The removable wall also secures insert trays or other additions that mount to the fixed wall. The removable wall also secures insert trays or other additions that mount to the fixed wall. The removable wall exposes a cable trough behind the fixed wall on the tray. It also can secure cables that pass through the cable slot. The removable wall also secures insert trays or other additions that mount to the fixed wall. The removable wall would also accommodate LED or other similar small lights in the top edge to illuminate the bare disc and game controllers when desired.

Height adjust lever 8—This mechanism locks the radial organizer relative to the long axis of the square tube. It is designed to easily be adjusted by the user.

Handles 7—These provide a convenient location to pull the radial organizer from the cabinet 18 while also providing a cosmetic accent.

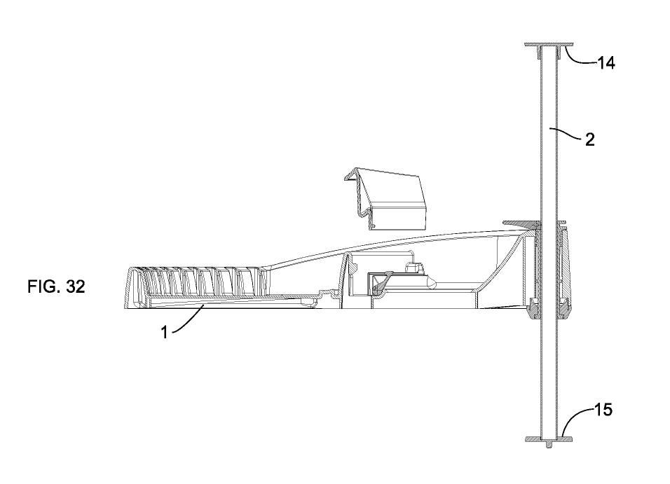

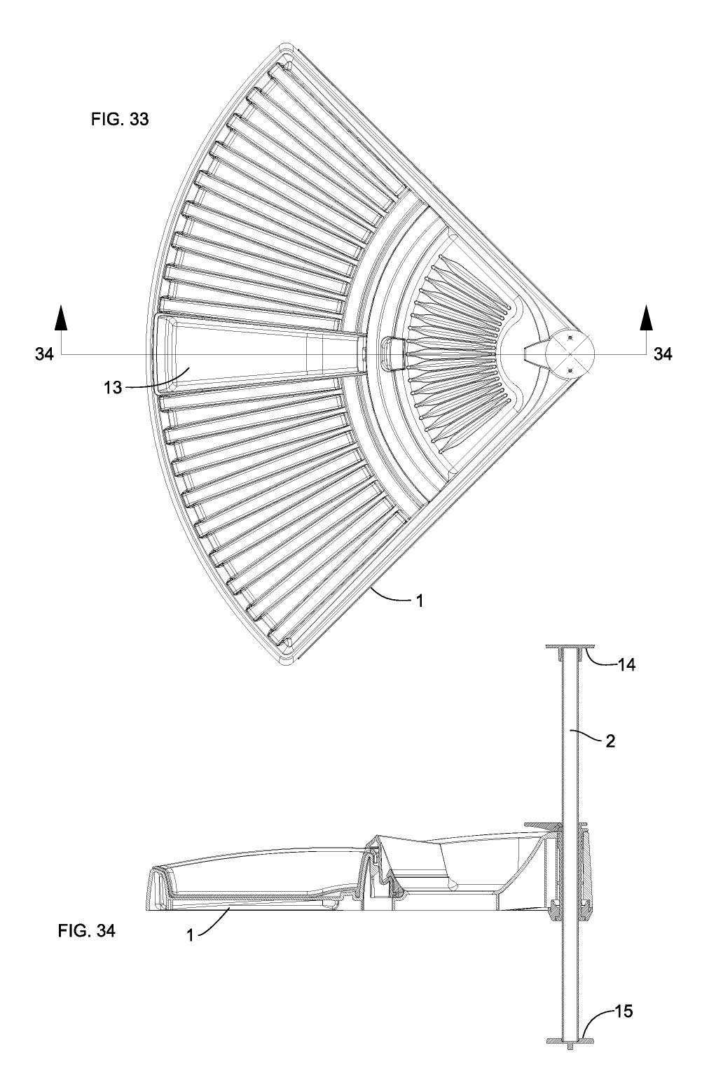

FIG. 32 is a cross sectional view of the multimedia storage organizer and rod with the lever 6 shown in the open position and the removable wall 5 shown separated from the multimedia storage organizer.

FIG. 33 is a top view of the multimedia storage organizer and rod with a controller tray inserted thereto. FIG. 34 is a cross sectional view. The controller tray 13 is inserted on top of the media slots 3 of the multimedia storage.

FIG. 34 is a cross sectional view of the multimedia storage organizer and rod along the section line 34-34 shown in FIG. 33. The controller bin 13 is shown secured to the multimedia storage organizer 1. A portion of the controller bin 13 extends over the fixed wall 16 and through the cable slot 17. The removable wall 5, when secured to the multimedia storage organizer 1, locks the controller bin 13 in place. The location of the controller bin may be changed by removing the removable wall 5, relocating the controller bin 13, and then locking the removable wall 5 back in place. In an alternative embodiment, the controller bin 13 may be permanently affixed to the multimedia storage organizer 1.

The controller bin 13 may be used to store game controllers, remotes, or other similarly sized items in generally upright positions in a compact high density manner. Additionally, the controller bin 13 may be used to create partitions of the media slots. In this manner, media cases may be organized by separating different categories with controller bins 13. While the controller bin 13 is shown occupying a plurality of media slots, it is nonetheless possible, and in some circumstances preferable, that the controller bin occupy a single media slot or even a fraction of a single media slot. In fact, many sizes and designs of controller bins may be possible, including designs that are form fitted to specific controller types, offer recharging options (wireless or wired), and store other media types such as CDs and CD cases. Preferably, the controller bin has a depth of at least one inch, a width of between one inch and three inches, and a length of at least five inches and is generally trapezoidal in shape.

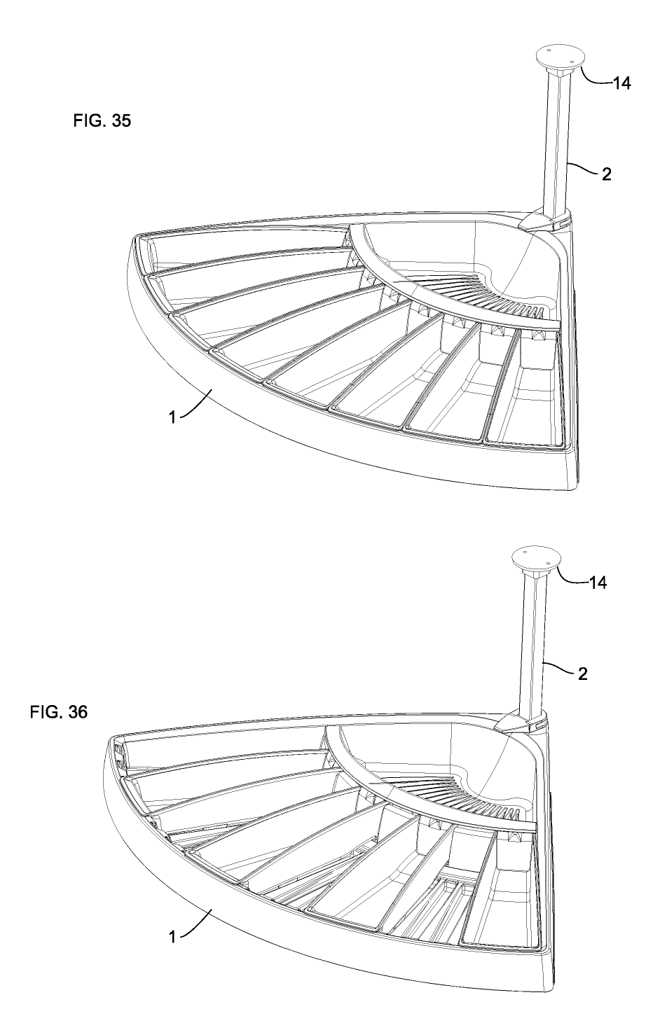

FIGS. 35 and 36 show different configurations of controller bins secured to the multimedia storage unit 1. FIG. 35 shows all of the media slots filled with controller bins 13. In this configuration, no storage of media cases is possible. FIG. 36, shows four controller bins 13 in the media slots, with gaps between the controller bins 13. In this configuration, the gaps are of the same size as the controller bins, and therefore can also be used to store controllers or other similarly sized items. Thus, using only four controller bins 13 creates eight sections for storing items. Further, depending upon specific dimensions of particular applications, nine sections may be created with only four controller trays.

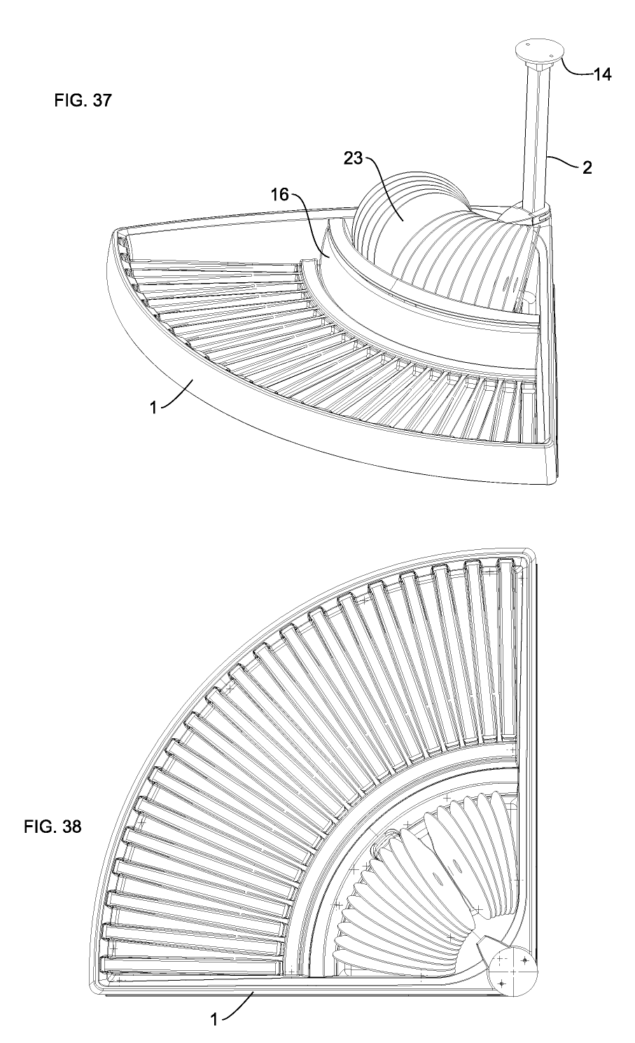

FIG. 37 is a pictorial view of the multimedia storage organizer with bare discs installed in the bare disc slots. FIG. 38 is a top view thereof. Bare discs 23 are stored in bare disc slots. Some of the bare discs 23 are shifted in one direction, while others are shifted in the opposite direction to allow a user to more easily view a specific bare disc 23.

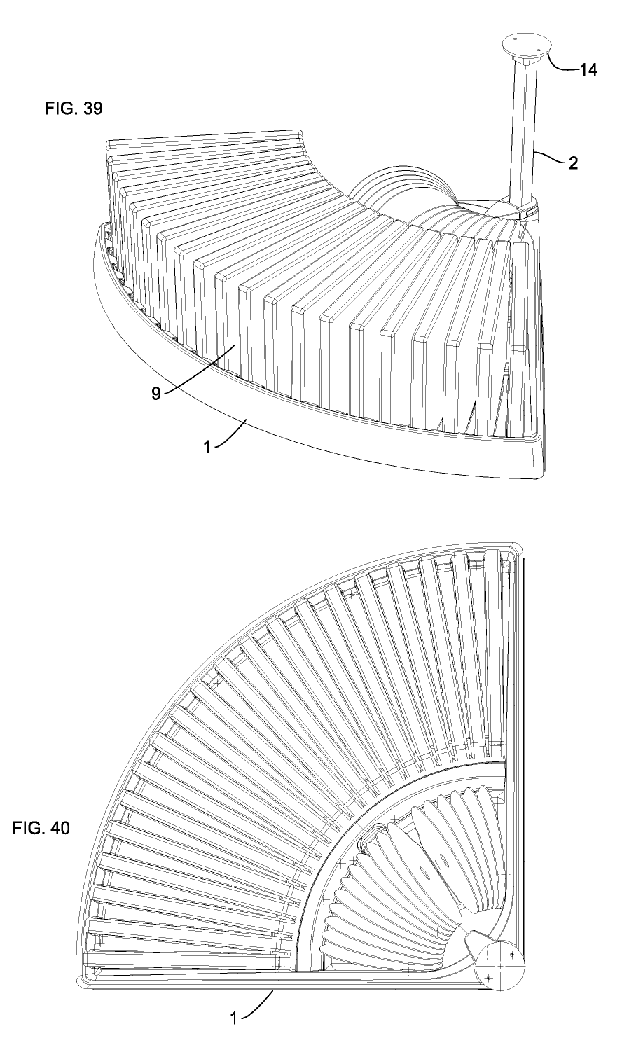

FIG. 39 is a pictorial view of the multimedia storage unit with bare disc and DVD style media cases installed thereto. FIG. 40 is a top view thereof. Media cases 9, in this instance DVD style media cases, reside in the media slots. Some of the bare discs 23 are shifted in one direction, while others are shifted in the opposite direction to allow a user to more easily view a specific bare disc 23.

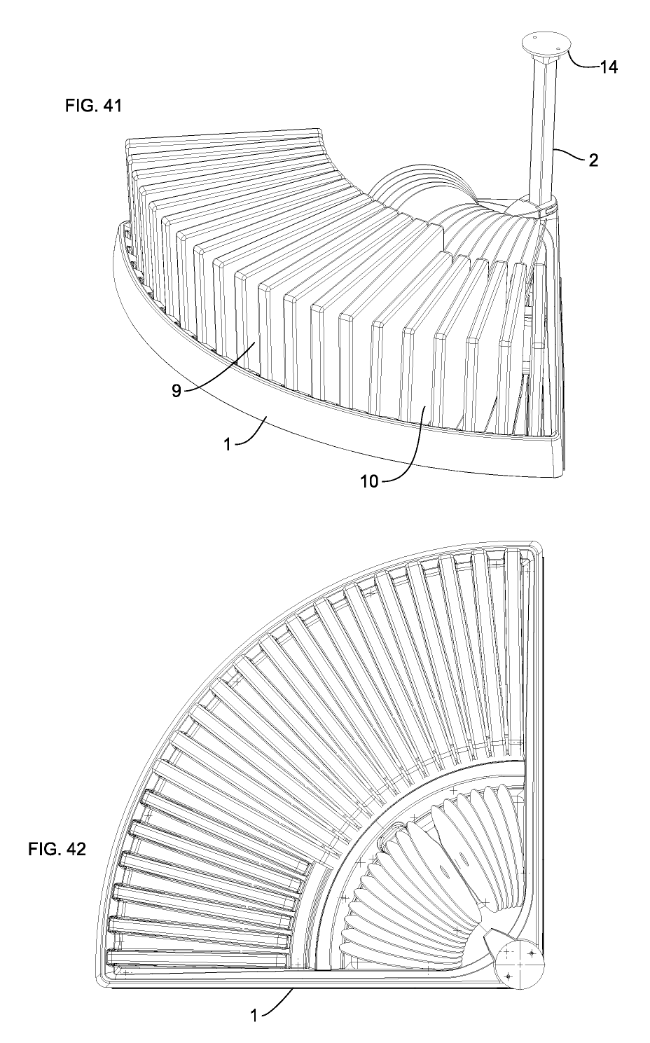

FIG. 41 is a pictorial view of the multimedia storage organizer with bare disc, DVD style, and Playstation® 3 or Blu-ray style media cases installed thereto. FIG. 42 is a top view thereof. In this iteration, both DVD style media cases 9 and Playstation® 3 or Blu-ray style media cases 10 reside in the media slots.

The square tube rod 2 is used to provide indexing of the radial trays in an open or closed position. The flat sides of the square tube interface with the top and bottom rod mounts to prevent the square tube rod 2 from rotating relative to the furniture cabinet or other surface to which it is affixed. With the rod 2 fixed relative to the cabinet, the radial bin provides a detent or a self-close mechanism to fixed positions relative to the square tube rod. If this indexing function is not required, the tube rod 2 may be allowed to rotate relative to the cabinet or the rod 2 may be a round tube or even a solid round pole. It should also be noted that shapes other than square may be used for indexing, such as rectangular or hexagonal shapes.

In an alternative embodiment, the rod may be an open square tube. Rather than the square tube having four sides, an open back or “U” shaped tube may also be used. With the open back opening to the rear of the cabinet, the open tubular rod may not be noticeable from an enclosed tube. However, the open back allows for cables to be run the axial length of the tubular rod without being seen.

In yet another alternative embodiment, the rod may have electrical contacts and internal electrical wiring. Rather than running cables down the length of the tubular rod, the rod may be electrified with external or internal contacts. These would extend down the length of the rod and connect to the top or bottom mounts, which could then be plugged into a power source. The radial organizer would have a swivel electrical connection at its point of rotation so that power may be provided to the organizer and may be used to charge various accessories.

The height adjustment lever is used to secure the multimedia storage organizer to the rod. As the lever is pulled up, it releases tension between the multimedia storage organizer and the rod. When the lever is pushed down, that tension is once again applied and a frictional force maintains the vertical position of the multimedia storage organizer on the rod.

An accessory relating to an embodiment of the current invention would be an under console fan that could mount under a plate located beneath the game consoles. This could draw air in from under the cabinet to cool the operating consoles.

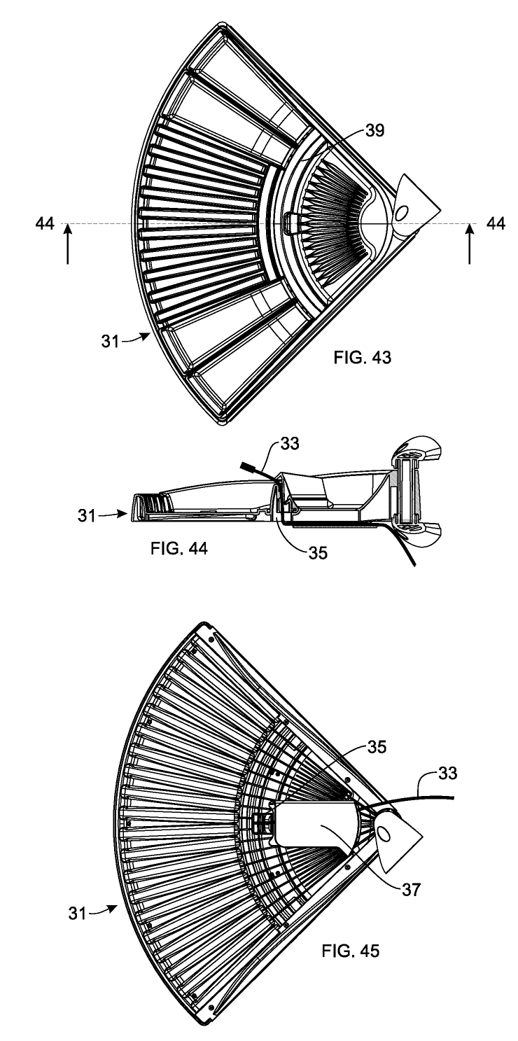

Referring now to FIGS. 43, 44 and 45 of the drawings, there is shown an organizer 31 which is similar in construction to the organizer 195 and the organizer 208, except that the routing device for cables is somewhat different. Cables such as recharging cable 33 shown in FIGS. 44 and 45 are routed through an opening 35 in the support surface for the organizer 31 to the underside thereof and then through a cable routing guide or clip 37 extending near the pivot point for the organizer 31.

Additionally, there is provided a removable cover or wall 39 as shown in FIG. 43 to cover over the cables and retain them in place.

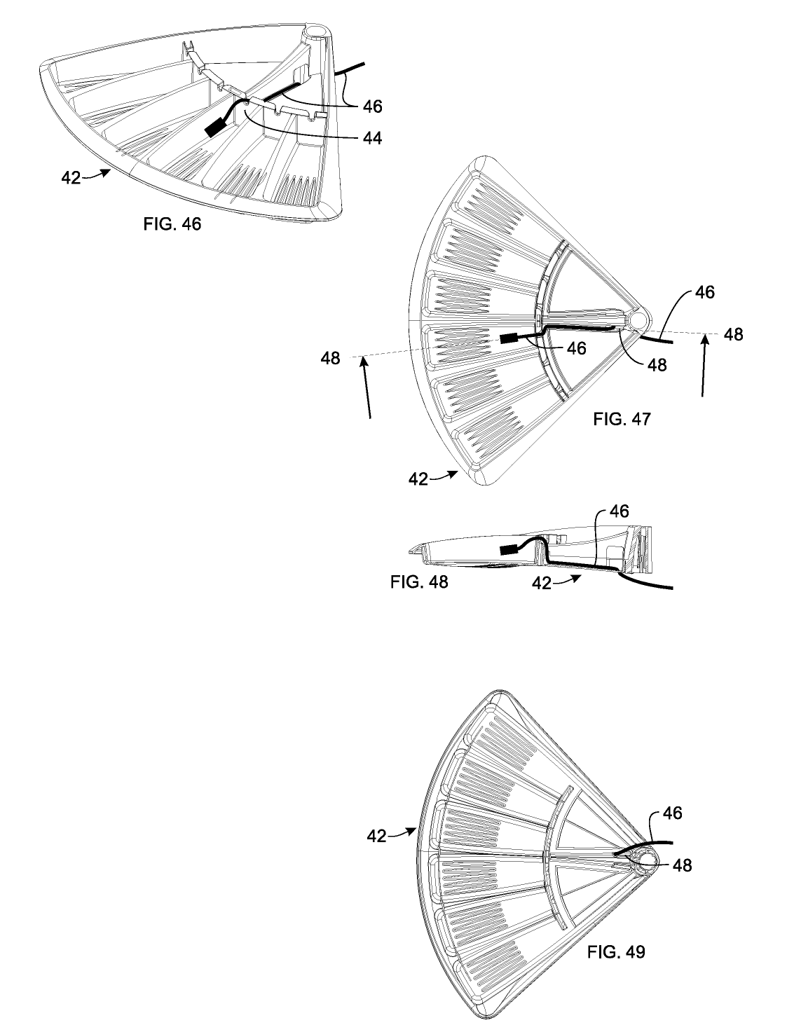

Referring now to FIGS. 46, 47, 48 and 49, an organizer 42 is constructed in accordance with an embodiment of the invention and is similar to the organizer 31 with the exception of the routing device. Cable routing notches such as the notch 44 shown in FIG. 46 secures a cable 46 in position relative to the electronic device receiving bin. The cable 46 extends from the notch 44 through an opening 48 to the underside of the organizer 42.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims define the present invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What is claimed is:

1. An organizer for storing and recharging electronic devices, comprising:
a support having a support surface for receiving and supporting the electronic devices;
a plurality of divider walls movably and repositionally adjustably mounted in a substantially spaced apart arrangement in an upright position on the support surface for enabling the electronic devices to be positioned on the support surface leaning against the divider walls;
securing means for movably and repositionally adjustably attaching the divider walls in an upright manner relative to the support surface;
routing means for positioning cables to the electronic devices leaning against the divider walls to maintain cables relative to individual divider walls and to facilitate recharging the electronic devices;
a series of means defining slots for receiving media for storage in a generally upright manner; and
wherein divider walls can be repositioned relative to other divider walls to accommodate different sizes and shapes of electronic devices.

2. An organizer according to claim 1, wherein the securing means includes a beaded edge on the support surface for receiving slidably generally c-shaped retainers on the divider walls.

3. An organizer according to claim 1, wherein pairs of the divider walls form portions of movable and positionable bins.

4. An organizer according to claim 1, wherein the divider walls are each generally thin rectangular plates.

5. An organizer according to claim 3, wherein the cable routing means includes means defining an opening in the bins for receiving cables.

6. An organizer according to claim 5, wherein the cable routing means further includes a removable wall for retaining and concealing cables.

7. An organizer according to claim 1, wherein the cable routing means includes at least one cable routing opening in the support surface.

8. An organizer according to claim 7, wherein the opening routes cable to the underside of the support, and wherein the cable routing means includes a cable routing guide on the underside of the support surface.

9. An organizer according to claim 1, wherein the support is rotatable and includes means for mounting it rotatably within a cabinet.

10. An organizer according to claim 9, wherein the support is generally triangular in shape having a pair of straight sides and an accurate front side, and includes an axle opening at a corner formed by the straight sides for mounting rotably on a vertical support rod.

11. An organizer for storing and electrically recharging electronic devices, comprising:
a support having an upper support surface;
a plurality of repositionable open top bins mounted movably on the support surface for each receiving and supporting individually an electronic device in an upright closely spaced manner;
securing means for movably and adjustably attaching the bins relative to the support surface to enable the accommodation of different sizes and shapes of electronic devices;
means for routing cables to the bins for recharging electronic devices stored individually therein; and
wherein electronic devices can be stored and recharged in the bins and other electronic devices can be stored and recharged on the support surface between the bins.

12. An organizer of claim 11, wherein the support includes media holders for storing media in an upright manner on the support surface.

13. An organizer according to claim 11, wherein each bin is in the form of an open top box, and includes a pair of spaced apart side walls serving as divider walls.

14. An organizer according to claim 13, wherein the support includes a fixed wall; and wherein the securing means includes clips on the bins to engage moveably the fixed support wall.

15. An organizer according to claim 11, wherein each divider wall has a height of at least one inch, and a length of at least five inches.

16. An organizer for storing and recharging electronic devices, comprising:
a support having a support surface;
a plurality of divider walls movably and repositionally adjustably mounted in a substantially spaced apart arrangement in an upright position on the support surface for enabling the electronic devices to be positioned on the support surface leaning against the divider wall;
securing means for movably and repositionally adjustably attaching the divider walls in an upright manner on the support surface;
a series of holders for supporting media in an upright manner on the support surface; and
wherein divider walls can be repositioned relative to other ones of the divider walls to accommodate different types and kinds of electronic devices.

17. An organizer according to claim 16, wherein pairs of the divider walls form parts of bins.

18. An organizer according to claim 17, wherein each bin is an open top box.

19. An organizer according to claim 17, wherein the bins each include a cable routing opening.

20. An organizer according to claim 18; wherein each bin has a depth of at least about one inch, a width of between about one inch and about three inches, and a length of at least about five inches.

21. An organizer according to claim 18, wherein each bin is generally trapezoidal in shape.

22. An organizer for electronic devices and media, comprising:
a support having a support surface;
a series of parallel spaced-apart upstanding divider walls fixed to the support surface, pairs of which define side walls of bins for enabling the electronic devices to lean against the divider walls and rest on the support surface;
cable routing means on the support for positioning cables relative to the divider walls;
wherein each bin has a depth of at least about one inch, a width between the divider walls of between about one inch and about three inches, and a length of at least five inches.

23. An organizer according to claim 22, wherein the support includes a rear wall and wherein the cable routing means includes means defining cable receiving opening at the bins.

24. A method of using an organizer for storing and recharging a plurality of electronic devices, comprising:
providing a support having a plurality of divider walls movably and positionally mounted on a support surface of the support in a generally parallel spaced-apart upright configuration;
relocating a divider wall on the support surface relative to another one of the divider walls to accommodate a certain electronic device therebetween;
leaning the certain electronic device on the support wall in a generally upright position; and
connecting a power cable to the electronic device.

25. A method according to claim 24, further providing a series of securing means on the support surface, attaching the divider walls to the support surface using the securing means in a moveable and adjustable manner; and
attaching and supporting in a generally upright position media in a parallel spaced apart manner with the electronic devices.

26. An organizer for storing and recharging electronic devices, comprising:
a support having a support surface for receiving and supporting the electronic devices;
a plurality of divider walls movably and repositionally adjustably mounted in a substantially spaced apart arrangement in an upright position on the support surface for enabling the electronic devices to be positioned on the support surface leaning against the divider walls;
securing means for movably and repositionally adjustably attaching the divider walls in an upright manner on the support surface;
routing means for positioning cables to the electronic devices leaning against the divider walls to maintain cables relative to individual divider walls and to facilitate recharging the electronic devices; and
wherein divider walls can be repositioned relative to other ones of the divider walls to accommodate different sizes and shapes of electronic devices.
